(19) United States
(12) Patent Application Publication
(10) Pub. No.: US 2026/0246194 A1
(43) Pub. Date: Aug. 20, 2026

(54) CONNECTOR UNIT

(71) Applicant: SUMITOMO WIRING SYSTEMS, LTD., Mie (JP)

(72) Inventors: Takuma HIRAKIMOTO, Mie (JP); Naoya AKIMOTO, Mie (JP)

(21) Appl. No.: 19/165,144

(22) PCT Filed: Mar. 1, 2024
(86) PCT No.: PCT/JP2024/007688

§ 371 Date: Sep. 15, 2025

(30) Foreign Application Priority Data
Mar. 22, 2023 (JP) 2023-044985

(51) Int. Cl. H01R 13/52; H01R 13/631

(52) U.S. Cl. CPC H01R 13/5213; H01R 13/631

(57) ABSTRACT

A connector unit includes a first connector and a second connector including a second housing and a connecting lever. A first housing includes an inner fitting peripheral wall portion and a protrusion projecting on an outer surface of the inner fitting peripheral wall portion. The second housing includes an outer fitting peripheral wall portion to be externally fit to the inner fitting peripheral wall portion. The outer fitting peripheral wall portion includes a slit for allowing the protrusion to pass and move therein at the time of connection. The connecting lever includes a lever body and an extended cover portion extending from the lever body and is supported to be rotationally movable between a standby position and a fastening position. The lever body has an operating surface. The operating surface is a surface for moving the protrusion toward the second housing.

### TECHNICAL FIELD

The present disclosure relates to a connector unit.

### BACKGROUND

Patent Document 1 discloses a waterproof connector connection structure provided with a first connector and a second connector. In Patent Document 1, the first connector includes a connection assist lever portion making a lever usable for a load force for connector connection to the second connector, and the second connector includes a connection guide projection to be fit into a connection guide groove of the connection assist lever portion. By fitting the connection guide projection into the connection guide groove of the connection assist lever portion, a force necessary for connector connection generated by a lever operation of the connection assist lever portion is transmitted.

### PRIOR ART DOCUMENT

### Patent Document

Patent Document 1: JP 2018-152265 A

### SUMMARY OF THE INVENTION

### Problems to be Solved

According to a technique disclosed in Patent Document 1, the connection guide projection projects outward through a connection guide slit formed in the first connector. Here, the dust resistance performance of a connector unit is desired to be further enhanced.

Accordingly, the present disclosure aims to further enhance the dust resistance performance of a connector unit.

### Means to Solve the Problem

The present disclosure is directed to a connector unit with a first connector including a first terminal and a first housing for accommodating the first terminal, and a second connector including a second terminal, a second housing for accommodating the second terminal and a connecting lever, the first housing including an inner fitting peripheral wall portion and a protrusion projecting on an outer surface of the inner fitting peripheral wall portion, the second housing including an outer fitting peripheral wall portion to be externally fit to the inner fitting peripheral wall portion, the outer fitting peripheral wall portion including a slit for allowing the protrusion to pass and move therein when the first and second housings are connected, the connecting lever including a lever body and an extended cover portion extending from the lever body, the connecting lever being supported to be rotationally movable between a standby position and a fastening position with respect to the second housing, the lever body having an operating surface for contacting the protrusion projecting from the slit when the first and second housings are connected, the operating surface being a surface for moving the protrusion toward the second housing by a rotational movement of the connecting lever from the standby position to the fastening position, and the extended cover portion extending toward an opening of the outer fitting peripheral wall portion along the slit with the connecting lever located at the fastening position.

### EFFECT OF THE INVENTION

According to the present disclosure, it is possible to further enhance the dust resistance performance of a connector unit.

### BRIEF DESCRIPTION OF THE DRAWINGS

FIG. 1 is a perspective view showing a connector unit according to an embodiment.

FIG. 2 is an exploded perspective view showing the connector unit.

FIG. 3 is a side view showing the connector unit before connection.

FIG. 4 is a diagram showing a connection operation example of the connector.

FIG. 5 is a diagram showing the connection operation example of the connector.

FIG. 6 is a diagram showing the connection operation example of the connector.

### DETAILED DESCRIPTION TO EXECUTE THE INVENTION

### Description of Embodiments of Present Disclosure

First, embodiments of the present disclosure are listed and described.

The connector unit of the present disclosure is as follows.
(1) The connector unit of the present disclosure is provided with a first connector including a first terminal and a first housing for accommodating the first terminal, and a second connector including a second terminal, a second housing for accommodating the second terminal and a connecting lever, the first housing including an inner fitting peripheral wall portion and a protrusion projecting on an outer surface of the inner fitting peripheral wall portion, the second housing including an outer fitting peripheral wall portion to be externally fit to the inner fitting peripheral wall portion, the outer fitting peripheral wall portion including a slit for allowing the protrusion to pass and move therein when the first and second housings are connected, the connecting lever including a lever body and an extended cover portion extending from the lever body, the connecting lever being supported to be rotationally movable between a standby position and a fastening position with respect to the second housing, the lever body having an operating surface for contacting the protrusion projecting from the slit when the first and second housings are connected, the operating surface being a surface for moving the protrusion toward the second housing by a rotational movement of the connecting lever from the standby position to the fastening position, and the extended cover portion extending toward an opening of the outer fitting peripheral wall portion along the slit with the connecting lever located at the fastening position.

According to the present disclosure, the extended cover portion extends toward the opening of the outer fitting peripheral wall portion along the slit with the connecting lever located at the fastening position. Thus, a part of the slit extending toward the opening of the outer fitting peripheral wall portion is covered by the extended cover portion in a connected state of the first and second connectors. In this way, dust is less likely to enter the connector unit via the slit, and the dust resistance performance of the connector unit can be further enhanced.
(2) In the connector unit of (1), a tip of the extended cover portion may be along a direction orthogonal to an extension direction of the slit with the connecting lever located at the fastening position.

If the tip of the extended cover portion is along the direction orthogonal to the extension direction of the slit with the connecting lever located at the fastening position in this way, the vicinity of an opening of the slit is easily covered by the extended cover portion.
(3) In the connector unit of (2), the extended cover portion may have a pair of side edges extending from both ends of the tip of the extended cover portion toward a base end side of the extended cover portion while being orthogonal to the tip.

In this case, since the extended cover portion has the pair of side edges extending from the both ends of the tip of the extended cover portion toward the base end side of the extended cover portion while being orthogonal to the tip, the extended cover portion can be made as small as possible in a range to cover the slit.
(4) In the connector unit of any one of (1) to (3), the extended cover portion may be located at an opening edge of the outer fitting peripheral wall portion with the connecting lever located at the fastening position.

In this way, the slit can be more effectively covered.
(5) In the connector unit of any one of (1) to (4), the first connector may include a plate portion projecting outward from a base end part of the inner fitting peripheral wall portion, and a tip of the extended cover portion may be facing the plate portion with the connecting lever located at the fastening position.

In this way, the entrance of dust through a tip side of the slit is suppressed.
(6) In the connector unit of (2) or (3), the extended cover portion may rotate from the standby position to the fastening position by way of an intermediate position, the operating surface may have a first operating surface for contacting the protrusion with the connecting lever located between the standby position and the intermediate position and a second operating surface for contacting the protrusion with the connecting lever located between the intermediate position and the fastening position, and a moving speed of the protrusion by the operating surface according to rotation of the connecting lever may be faster by the second operating surface than by the first operating surface.

In this way, the first and second connectors are fastened to quickly approach after the connecting lever moves beyond the intermediate position. Thus, the first and second connectors are connected by avoiding the interference of the extended cover portion and the first connector while extending the extended cover portion toward the first connector as much as possible.

### DETAILS OF EMBODIMENT OF PRESENT DISCLOSURE

A specific example of a connector unit of the present disclosure is described with reference to the drawings below. Note that the present disclosure is not limited to these illustrations, but is represented by claims and intended to include all changes in the scope of claims and in the meaning and scope of equivalents.

### Embodiment

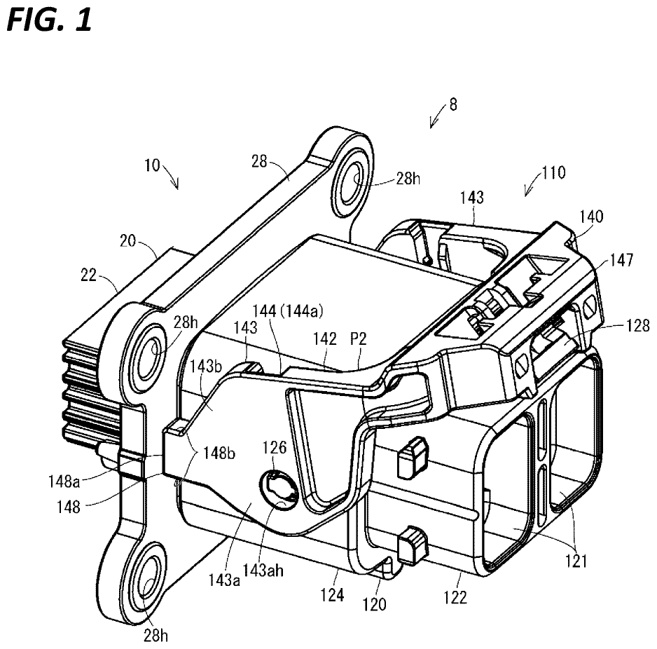

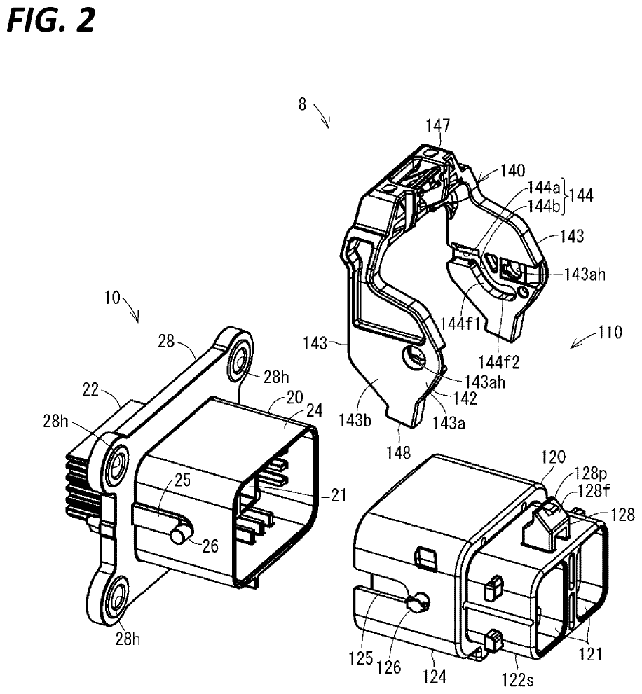

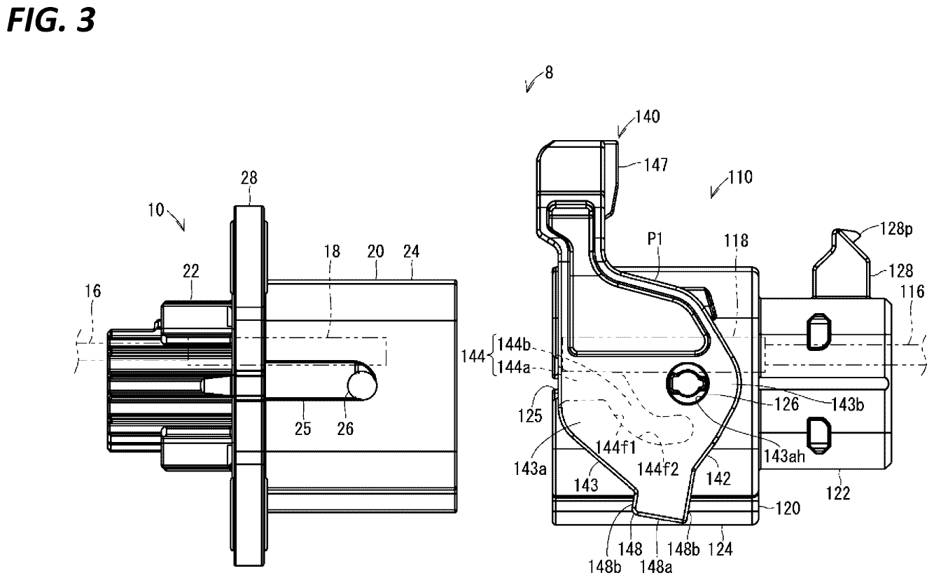

Hereinafter, a connector unit according to an embodiment is described. FIG. 1 is a perspective view showing a connector unit 8. FIG. 2 is an exploded perspective view showing the connector unit 8. FIG. 3 is a side view showing the connector unit 8 before connection.

The connector unit 8 is provided with a first connector 10 and a second connector 110

The first connector 10 is provided with a first housing 20 and first terminals 18.

The first terminal 18 is formed, such as by press-working a metal plate. The first terminal 18 is a terminal in which a connecting portion and a wire connecting portion are connected. The connecting portion of the first terminal 18 is a part to be connected to a second terminal 118 on the side of the second connector 110. For example, the connecting portion of the first terminal 18 is formed into a rectangular plate shape or a pin shape. The wire connecting portion is a part to be connected to an end part of a wire 16. For example, the wire connecting portion is crimped and connected to the end part of the wire 16. The wire connecting portion may be joined to the wire by ultrasonic welding, resistance welding or the like. It is not essential that the first terminal 18 is connected to the wire. For example, the first terminal may be connected to a circuit formed on a circuit board.

The first housing 20 is a resin component for accommodating the first terminals 18. The first housing 20 is formed with cavities 21 for accommodating the first terminals 18, and the first terminals 18 are accommodated and held in the cavities 21.

More specifically, the first housing 20 includes a housing body 22, an inner fitting peripheral wall portion 24, protrusions 26 and a plate portion 28.

The cavities 21 are formed to penetrate through the housing body 22. The first terminal 18 is held in the housing body 22 by inserting the first terminal 18 connected to the end part of the wire 16 into the cavity 21. The connecting portion of the first terminal 18 is exposed on a tip side of the housing body 22, and the wire 16 is pulled out from the rear end of the housing body 22.

The inner fitting peripheral wall portion 24 is a tubular part for surrounding the connecting portions of the first terminals 18. In this embodiment, the inner fitting peripheral wall portion 24 is formed into a rectangular tube shape with rounded corners. The connecting portions of the first terminals 18 are exposed in the inner fitting peripheral wall portion 24. The inner fitting peripheral wall portion 24 is inserted and connected to an outer fitting peripheral wall portion 124 to be described later.

The plate portion 28 is a plate-like part projecting outward from a base end part of the inner fitting peripheral wall portion 24. In this embodiment, the plate portion 28 is in the form of a plate projecting from the entire periphery of the inner fitting peripheral wall portion 24. The plate portion 28 is, for example, a part for mounting the first connector 10 on a component to be attached, e.g. a device case. For example, screw insertion holes 28h are formed in corner parts of the plate portion 28. Screws are screwed and fastened into screw holes formed in the component to be attached while being inserted through the screw insertion holes 28h. In this way, the first connector 10 is fixed to the component to be attached. The inner fitting peripheral wall portion 24 projects from one principal surface of the plate portion 28.

The protrusion 26 is a convex shape part projecting on the outer surface of the inner fitting peripheral wall portion 24. In this embodiment, the protrusion 26 is formed on the outer surface of a side wall of the inner fitting peripheral wall portion 24. More specifically, a guide protrusion 25 extending along an axial direction of the inner fitting peripheral wall portion 24 is formed on the side wall of the inner fitting peripheral wall portion 24. One end of the guide protrusion 25 is located at the plate portion 28, and the other end is located between the base end and the tip of the inner fitting peripheral wall portion 24. The protrusion 26 projects on a tip part of the guide protrusion 25. That is, the elongated guide protrusion 25 projects on the side wall of the inner fitting peripheral wall portion 24, and the protrusion 26 projects on the tip of the guide protrusion 25.

The guide protrusion 25 can be inserted into a slit 125 formed in a second housing 120. A projecting dimension of the guide protrusion 25 from the outer surface of the inner fitting peripheral wall portion 24 is so set that the guide protrusion 25 does not project on the outer surface of the outer fitting peripheral wall portion 124 of the second housing 120. A projecting dimension of the protrusion 26 is larger than that of the guide protrusion 25 and so set that the protrusion 26 projects on the outer surface of the outer fitting peripheral wall portion 124. It is not essential that the guide protrusion 25 is provided, and only a protrusion may project from the outer surface of an inner fitting peripheral wall portion.

In this embodiment, the guide protrusion 25 and the protrusion 26 are formed on each of both side surfaces of the inner fitting peripheral wall portion 24. The first housing 20 may be provided with at least one protrusion 26. The following description is mainly focused on one side surface.

The second connector 110 is provided with the second terminals 118, a second housing 120 and a connecting lever 140.

The second terminal 118 is formed, such as by press-working a metal plate. The second terminal 118 is a terminal in which a connecting portion and a wire connecting portion are connected, similarly to the first terminal 18. The connecting portion of the second terminal 118 is a part to be connected to the first terminal 18 on the side of the first connector 10. For example, the connecting portion of the second terminal 118 is in the form of a tube, into which the first terminal 18 is insertable. The wire connecting portion is a part to be connected to an end part of a wire 116. The wire connecting portion of the second terminal 118 may also be connected to a circuit formed on a circuit board.

Note that the connecting portion of the first terminal 18 may be formed into a plate shape or a pin shape, and the connecting portion of the second terminal 118 may be formed into a tubular shape.

The second housing 120 is a resin component for accommodating the second terminals 118. The second housing 120 is formed with cavities 121 for accommodating the second terminals 118, and the second terminals 118 are accommodated and held in the cavities 121.

More specifically, the second housing 120 is provided with a housing body 122 and the outer fitting peripheral wall portion 124.

The cavities 121 are formed to penetrate through the housing body 122. The second terminal 118 is held in the housing body 122 by inserting the second terminal 118 connected to the end part of the wire 116 into the cavity 121. A tip opening of the connecting portion of the second terminal 118 is facing toward the tip side of the housing body 122, and the wire 116 is pulled out from the rear end of the housing body 122.

The outer fitting peripheral wall portion 124 is a tubular part for surrounding the connecting portions of the second terminals 118. In this embodiment, the outer fitting peripheral wall portion 124 is formed into a rectangular tube shape with rounded corners. The inner peripheral surface of the outer fitting peripheral wall portion 124 is formed into a shape having the same size as or larger than the outer peripheral surface of the inner fitting peripheral wall portion 24. For example, the inner peripheral surface of the outer fitting peripheral wall portion 124 may be larger than the outer peripheral surface of the inner fitting peripheral wall portion 24 to such an extent that the inner fitting peripheral wall portion 24 can be inserted into the outer fitting peripheral wall portion 124 without rattling. This outer fitting peripheral wall portion 124 is externally fit to the inner fitting peripheral wall portion 24.

The connecting portion of the second terminal 118 is located in the outer fitting peripheral wall portion 124. With the inner fitting peripheral wall portion 24 inserted in the outer fitting peripheral wall portion 124, the connecting portion of the first terminal 18 is connected to the connecting portion of the second terminal 118 in a space surrounded by the inner fitting peripheral wall portion 24 and the outer fitting peripheral wall portion 124. In this way, the wires 16, 116 are electrically connected via the first and second terminals 18, 118.

By arranging a connected part of the first and second terminals 18, 118 inside the inner fitting peripheral wall portion 24 and the outer fitting peripheral wall portion 124, dirt, dust and the like hardly enter the connected part.

The outer fitting peripheral wall portion 124 is formed with slits 125. The slits 125 are formed to allow the protrusions 26 to pass and move at the time of connecting the first and second housings 20, 120.

More specifically, the slits 125 along a connection direction of the first and second housings 20, 120 are formed in side parts of the outer fitting peripheral wall portion 124. The slit 125 is formed to extend from an intermediate point between the base end and the tip of the outer fitting peripheral wall portion 124 toward the tip of the outer fitting peripheral wall portion 124. The position of the slit 125 on a back side is a position where the protrusion 26 is arranged in the connected state of the connectors 10, 110.

A width of the slit 125 is equal to or larger than that of the guide protrusion 25. For example, the width of the slit 125 may be larger than that of the guide protrusion 25 within such a range that the guide protrusion 25 can be guided to enable smooth connection of the connectors 10, 110.

In the connected state of the connectors 10, 110, the guide protrusion 25 is preferably arranged in the entire slit 125 in a longitudinal direction, but this is not essential.

The width of the slit 125 is equal to or larger than that of the protrusion 26 in a direction orthogonal to the slit 125. Thus, if the inner fitting peripheral wall portion 24 is inserted into the outer fitting peripheral wall portion 124, the protrusions 26 enter the slits 125 through the tip side of the outer fitting peripheral wall portion 124 and can pass and move to the backs of the slits 125 along the slits 125.

In this embodiment, a pair of the slits 125 are formed in the both side parts of the outer fitting peripheral wall portion 124 to correspond to a pair of the protrusions 26. Similarly to the protrusions 26, the outer fitting peripheral wall portion 124 only has to include at least one slit 125.

The outer fitting peripheral wall portion 124 is formed with shaft portions 126. In this embodiment, the shaft portions 126 project on the extensions of the back sides of the slits 125 in the both side surfaces of the outer fitting peripheral wall portion 124. The connecting lever 140 is rotatably supported by the shaft portions 126.

A lever stopping protrusion 128 projects on a base end part of the housing body 122. A part of the lever stopping protrusion 128 on a side where the wires 116 extend out is formed with an inclined surface 128f inclined with respect to the connection direction of the connectors 10, 110. A locking protrusion 128p is formed on this inclined surface 128f. By locking the locking protrusion 128p to the connecting lever 140, the connecting lever 140 is held at a predetermined position.

The connecting lever 140 includes a lever body 142 and extended cover portions 148 and is supported to be rotationally movable between a standby position P1 (see FIG. 3) and a fastening position P2 (see FIG. 1) with respect to the second housing 120.

More specifically, the connecting lever 140 is a component made of resin or the like. The lever body 142 includes a pair of side portions 143 and an operating portion 147 coupling the pair of side portions 143.

The side portion 143 is in the form of a plate extending along the side surface of the outer fitting peripheral wall portion 124. For example, the side portion 143 includes a rotation support region part 143a and an operating surface forming region part 143b.

The rotation support region part 143a is a plate-like part including a hole 143ah, into which the shaft portion 126 is fit. The operating surface forming region part 143b is a plate-like part partially spreading around the hole 143ah. The operating surface forming region part 143b spreads along the side surface of the outer fitting peripheral wall portion 124 and extends out from the side surface of the outer fitting peripheral wall portion 124.

Both end parts of the operating portion 147 are coupled to parts extending from the side surfaces of the outer fitting peripheral wall portion 124, out of the operating surface forming region parts 143b of the pair of respective side portions 143. Thus, the operating portion 147 couples the pair of side portions 143 outside the outer fitting peripheral wall portion 124. By operating the operating portion 147, the pair of operating portions 147 can be interlocked and rotationally moved.

The pair of shaft portions 126 of the outer fitting peripheral wall portion 124 are respectively fit into the holes 143ah of the pair of side portions 143, whereby the connecting lever 140 is supported to be rotationally movable between the standby position P1 and the fastening position P2. Note that the operating portion 147 is arranged outside the outer fitting peripheral wall portion 124 on the side of the lever stopping protrusion 128. In the following description, the side of the lever stopping protrusion 128 with respect to the second housing 120 may be referred to as an upper side and an opposite side thereof may be referred to as a lower side.

The standby position P1 is a position of the connecting lever 140 before the connection of the connectors 10, 110. At the standby position P1, the operating surface forming region part 143b is located at least in a region extending downward from the tip side of the outer fitting peripheral wall portion 124 with respect to the shaft portion 126. The operating portion 147 is located above the outer fitting peripheral wall portion 124 and closer to the tip side of the outer fitting peripheral wall portion 124 than the shaft portion 126 (see FIG. 3).

The fastening position P2 is a position of the connecting lever 140 in the connected state of the connectors 10, 110. At the fastening position P2, the operating surface forming region part 143b is located at least in a region from the upper side to the tip side of the outer fitting peripheral wall portion 124 with respect to the shaft portion 126 (see FIG. 1). The operating portion 147 is located above the second housing 120 and closer to the base end side of the outer fitting peripheral wall portion 124 than the shaft portion 126, and locked to the lever stopping protrusion 128.

The side portion 143 of the lever body 142 has operating surfaces 144f1, 144f2. The operating surfaces 144f1, 144f2 are surfaces for contacting the protrusion 26 projecting from the slit 125 when the first and second housings 20, 120 are connected. The operating surfaces 144f1, 144f2 are formed to move the protrusion 26 toward the second housing 120 by a rotational movement of the connecting lever 140 from the standby position P1 to the fastening position P2.

More specifically, a groove 144 is formed in the inner surface of the side portion 143. The groove 144 includes an introducing groove portion 144a and a fastening groove portion 144b.

The introducing groove portion 144a is a groove extending straight from an edge part of the operating surface forming region part 143b toward the hole 143ah. The introducing groove portion 144a is open outward from the edge part of the operating surface forming region part 143b. Thus, the protrusion 26 can enter the groove 144 through an opening in an end part of the introducing groove portion 144a.

The fastening groove portion 144b is an arcuate groove extending to be concave on the side of the hole 143ah. One end of the fastening groove portion 144b is connected to the introducing groove portion 144a, and the protrusion 26 can enter the fastening groove portion 144b from the introducing groove portion 144a.

The fastening groove portion 144b extends to gradually approach the hole 143ah from the introducing groove portion 144a toward a back side. If the connecting lever 140 is rotated from the standby position P1 toward the fastening position P2 with the protrusion 26 located in the fastening groove portion 144b, the protrusion 26 moves toward the back side along the fastening groove portion 144b. Then, the operating surfaces 144f1, 144f2, which are surfaces on an outer peripheral side of the fastening groove portion 144b, contact the protrusion 26 and pushes the protrusion 26 toward the hole 143ah, i.e. the shaft portion 126. In this way, the protrusion 26 moves toward the second housing 120 and the first and second housings 20, 120 move in directions approaching each other.

Out of the operating surfaces 144f1, 144f2 located on the outer peripheral side of the fastening groove portion 144b, the first operating surface 144f1 is located on an outer opening and the second operating surface 144f2 is located on the back side.

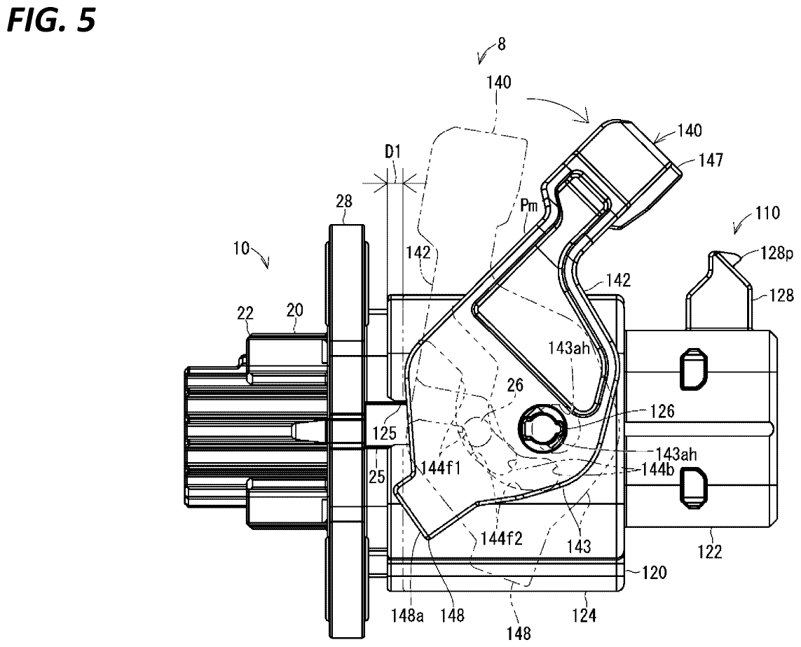

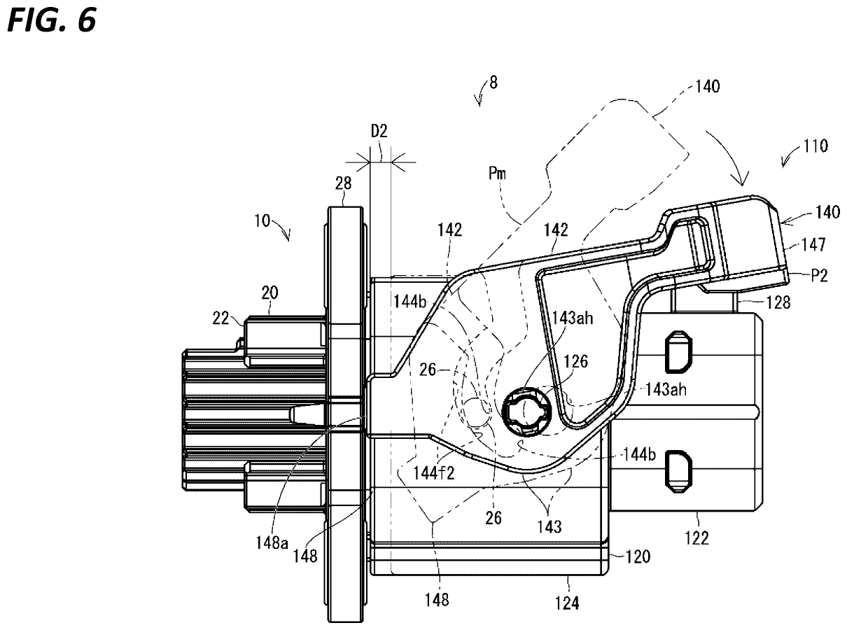

A moving speed of the protrusion 26 by the second operating surface 144f2 according to the rotation of the connecting lever 140 is faster than a moving speed of the protrusion 26 by the first operating surface 144f1. Here, the moving speed of the protrusion 26 according to the rotation of the connecting lever 140 is defined by a moving distance of the protrusion 26 (i.e. a moving distance of the second housing 120) per a predetermined rotation angle of the connecting lever 140. For example, as shown in FIG. 5, a movement amount of the protrusion 26 (i.e. the second connector 110) per unit angle change of the connecting lever 140 before an intermediate position Pm is D1. As shown in FIG. 6, a movement amount of the protrusion 26 (i.e. the second connector 110) per unit angle change of the connecting lever 140 after the intermediate position Pm is D2. The movement amount D2 is larger than the movement amount D1 and, if the connecting lever 140 is rotated at the same angular speed, an approaching speed of the connectors 10, 110 becomes faster after the connecting lever 140 moves beyond the middle Pm.

For example, a value obtained by dividing a distance difference between one end and the other end of the second operating surface 144f2 to a center of the protrusion 26 by an angle range about the protrusion 26 in which the second operating surface 144f2 is present is larger than a value obtained by dividing a distance difference between one end and the other end of the first operating surface 144f1 to the center of the protrusion 26 by an angle range about the protrusion 26 in which the first operating surface 144f1 is present.

In this way, when the connecting lever 140 is rotationally moved from the standby position P1 to the fastening position P2, the first and second housings 20, 120 can be quickly brought closer in a final stage after the first and second housings 20, 120 are slowly brought closer.

Here, it is thought that the extended cover portion 148 rotates from the standby position P1 to the fastening position P2 by way of the intermediate position Pm. A position where a target to be contacted by the protrusion 26 is switched from the first operating surface 144f1 to the second operating surface is the intermediate position Pm. That is, the first operating surface 144f1 is in contact with the protrusion 26 with the connecting lever 140 located between the standby position P1 and the intermediate position Pm. The second operating surface 144f2 is in contact with the protrusion 26 with the connecting lever 140 located between the intermediate position Pm and the fastening position P2.

A set example of the intermediate position Pm is described later.

The extended cover portion 148 extends toward the opening of the outer fitting peripheral wall portion 124 along the slit 125 with the connecting lever 140 located at the fastening position P2 (see FIGS. 1 and 6). Note that the extended cover portion 148 is larger than the width of the slit 125 and can entirely cover the slit 125 in a width direction.

The extended cover portion 148 is a part partially projecting from a peripheral edge part of the side portion 143. That is, the extended cover portion 148 is a part projecting from a surrounding part thereof in a circumferential direction about the shaft portion 126.

A tip 148a of the extended cover portion 148 is an edge extending straight, and may extend along a direction orthogonal to an extension direction of the slit 125 with the connecting lever 140 located at the fastening position P2. Note that, in the present disclosure, orthogonal means to be orthogonal within a tolerance range and may include, for example, a range of ±5° with respect to 90° or a range of ±3° with respect to 90°.

Further, the extended cover portion 148 may have a pair of side edges 148b extending from both ends of the tip 148a of the extended cover portion 148 toward a base end side of the extended cover portion 148 while being orthogonal to the tip 148a. With the connecting lever 140 located at the fastening position P2, the pair of side edges 148b extend along and outside both side edges of the slit 125.

With the connecting lever 140 located at the fastening position P2, the extended cover portion 148 is preferably located at the opening edge of the outer fitting peripheral wall portion 124. Note that, if the extended cover portion 148 is located at the opening edge of the outer fitting peripheral wall portion 124, the tip 148a of the extended cover portion 148 and the opening edge of the outer fitting peripheral wall portion 124 may be at the same position or the tip 148a may be located beyond the opening edge of the outer fitting peripheral wall portion 124 in the connection direction of the connectors 10, 110.

Note that the tip 148a of the extended cover portion 148 may be located in front of the opening edge of the outer fitting peripheral wall portion 124.

Further, in the connected state of the connectors 10, 110, the tip 148a of the extended cover portion 148 is preferably facing the plate portion 28. In this state, a gap may be formed or no gap may be formed between the tip 148a and the plate portion 28.

A connection operation example of the connectors 10, 110 is described below.

As shown in FIG. 3, the first and second connectors 10, 110 are prepared. The connecting lever 140 is located at the standby position P1. The introducing groove portion 144a is along the slit 125. The outer opening of the introducing groove portion 144a is facing toward the second connector 110 outside the slit 125.

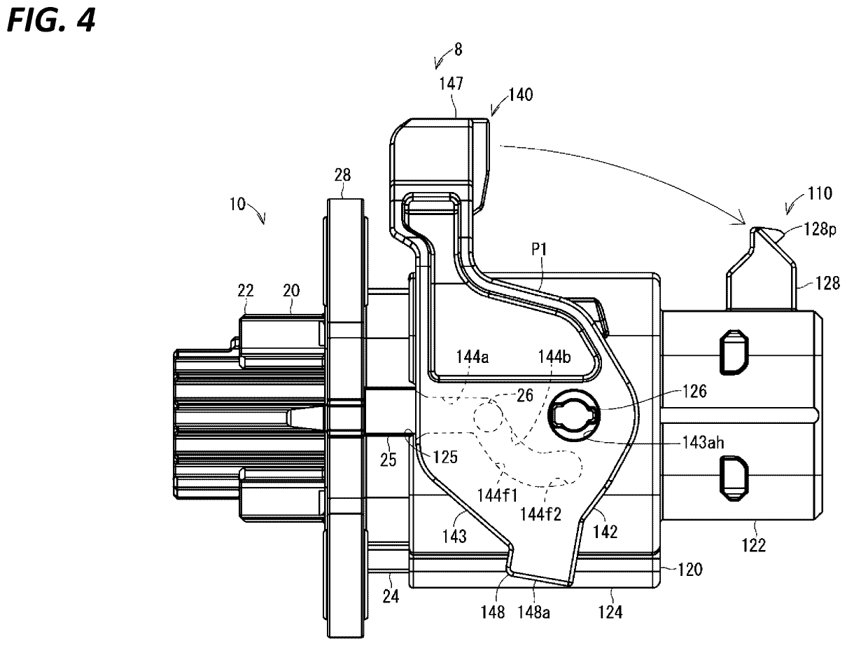

The first and second connectors 10, 110 are brought closer. Then, as shown in FIG. 4, the inner fitting peripheral wall portion 24 is inserted into the outer fitting peripheral wall portion 124. With the inner fitting peripheral wall portion 24 inserted halfway in the outer fitting peripheral wall portion 124, the guide protrusion 25 enters the slit 125. Further, the protrusion 26 enters the slit 125 and the introducing groove portion 144a on the outer side.

The first and second connectors 10, 110 are further brought closer and the protrusion 26 enters a boundary between the introducing groove portion 144a and the fastening groove portion 144b. Thereafter, the operating portion 147 is manually operated to rotate the connecting lever 140 from the standby position P1 to the fastening position P2.

Then, as shown in FIG. 5, the fastening groove portion 144b rotates around the shaft portion 126, wherefore the protrusion 26 moves toward the back side of the fastening groove portion 144b. Initially, the first operating surface 144f1 contacts the protrusion 26 to move the protrusion 26 toward the second connector 110. In this way, the first connector 10 is relatively pulled toward the second connector 110.

If the connecting lever 140 is further rotated toward the fastening position P2, the second operating surface 144f2 contacts the protrusion 26. In this way, the protrusion 26 is moved more quickly toward the second connector than before. In this way, the first connector 10 is further relatively pulled toward the second connector 110.

To cover the vicinity of the tip of the slit 125 by the extended cover portion 148, the extended cover portion 148 is preferably made as long as possible. If the extended cover portion 148 is made longer, there is a possibility that an end of the tip 148a protrudes more from the tip of the outer fitting peripheral wall portion 124. If the extended cover portion 148 protrudes from the tip of the outer fitting peripheral wall portion 124 during the connection, the extended cover portion 148 possibly interferes with the plate portion 28 to hinder smooth connection of the connectors 10, 110.

Accordingly, by increasing the approaching speed of the connectors 10, 110 after the connecting lever 140 approaches the fastening position P2 beyond the intermediate position Pm, a protruding timing of the extended cover portion 148 from the tip of the outer fitting peripheral wall portion 124 can be delayed.

If the protruding timing of the extended cover portion 148 from the tip of the outer fitting peripheral wall portion 124 can be delayed, the tip 148a can be set in a posture along the plate portion 28 in a state where the tip 148a possibly interferes with the plate portion 28. If the tip 148a is in the posture along the plate portion 28, the contact of the extended cover portion 148 with the plate portion 28 hardly hinders the rotation of the connecting lever 140.

From the above point of view, the intermediate position Pm is preferably a position where the tip 148a is at an angle equal to or less than 45° to the plate portion 28, i.e. at an angle equal to or less than 45° to the extension direction of the slit 125.

If the connecting lever 140 reaches the fastening position P2, the lever stopping protrusion 128 is locked to the operating portion 147 of the connecting lever 140. In this way, the connecting lever 140 is held at the fastening position P2 and the connected state of the connectors 10, 110 is maintained.

According to the connector unit 8 configured as described above, the extended cover portion 148 extends toward the opening of the outer fitting peripheral wall portion 124 along the slit 125 with the connecting lever 140 located at the fastening position P2. Thus, in the connected state of the connectors 10, 110, a part of the slit 125 extending toward the opening of the outer fitting peripheral wall portion 124 is covered by the extended cover portion 148. In this way, a so-called labyrinth structure is realized, dust is less likely to enter the connector unit 8 through the slit 125 and the dust resistance performance of the connector unit 8 can be further enhanced. As a result of enhancing the dust resistance performance, the connector unit 8 is suitably incorporated into a device required to have high dust resistance performance such as a device including a battery.

Further, if the tip 148a of the extended cover portion 148 is along the direction orthogonal to the extension direction of the slit 125 with the connecting lever 140 located at the fastening position P2, the vicinity of the opening of the slit 125 is easily entirely covered by the extended cover portion 148 as compared to the case where a tip of an extended cover portion is bent.

Further, if the extended cover portion 148 has the pair of side edges 148b extending from the both ends of the tip 148a toward the base end side of the extended cover portion 148 while being orthogonal to the tip 148a, the extended cover portion 148 can be made as small as possible in a range to cover the slit 125.

Further, if the extended cover portion 148 is located at the opening edge of the outer fitting peripheral wall portion 124 with the connecting lever 140 located at the fastening position P2, the slit 125 can be more effectively covered and the dust resistance performance can be further enhanced.

Further, if the tip of the extended cover portion 148 is facing the plate portion 28 with the connecting lever 140 located at the fastening position P2, the entrance of dust from the tip side of the slit 125 is suppressed.

Further, the operating surface includes the first and second operating surfaces 144f1, 144f2, and the second operating surface 144f2 brings the protrusion 26 toward the second connector 110 faster than the second operating surface 144f2. Thus, if the connecting lever 140 moves beyond the intermediate position, the first and second connectors 10, 110 are fastened to quickly approach. In this way, the connectors 10, 110 are smoothly connected by avoiding the interference of the extended cover portion 148 and the first connector 10 while extending the extended cover portion 148 toward the first connector 10 as much as possible.

If the intermediate position Pm is a position where the tip 148a of the extended cover portion 148 is at an angle equal to or more than 45° to the extension direction of the slit 125, the connectors 10, 110 quickly approach after the connecting lever 140 moves beyond the intermediate position Pm. At this time, even if the tip 148a interferes with the plate portion 28, the tip 148a can be smoothly displaced along the principal surface of the plate portion 28. Thus, the tip 148a of the extended cover portion 148 is possibly easily guided along the extension direction of the slit 125. Therefore, the connectors 10, 110 can be smoothly connected while the extended cover portion 148 is made as long as possible toward the first connector 10.

Note that the respective configurations described in the above embodiment and each modification can be combined as appropriate without contradicting each other.

### LIST OF REFERENCE NUMERALS

8 connector unit
10 first connector
16, 116 wire
18 first terminal
20 first housing
21, 121 cavity
22, 122 housing body
24 inner fitting peripheral wall portion
25 guide protrusion
26 protrusion
28 plate portion
28h screw insertion hole
110 second connector
118 second terminal
120 second housing
124 outer fitting peripheral wall portion
125 slit
126 shaft portion
128 lever stopping protrusion
128f inclined surface
128p locking protrusion
140 connecting lever
142 lever body
143 side portion
143a rotation support region part
143ah hole
143b operating surface forming region part
144 groove
144a introducing groove portion
144b fastening groove portion
144f1 first operating surface
144f2 second operating surface
147 operating portion
148 extended cover portion
148a tip
148b side edge
P1 standby position
P2 fastening position
Pm intermediate position

1. A connector unit, comprising:
a first connector including a first terminal and a first housing for accommodating the first terminal; and
a second connector including a second terminal, a second housing for accommodating the second terminal and a connecting lever,
the first housing including an inner fitting peripheral wall portion and a protrusion projecting on an outer surface of the inner fitting peripheral wall portion,
the second housing including an outer fitting peripheral wall portion to be externally fit to the inner fitting peripheral wall portion,
the outer fitting peripheral wall portion including a slit for allowing the protrusion to pass and move therein when the first and second housings are connected,
the connecting lever including a lever body and an extended cover portion extending from the lever body, the connecting lever being supported to be rotationally movable between a standby position and a fastening position with respect to the second housing,
the lever body having an operating surface for contacting the protrusion projecting from the slit when the first and second housings are connected,
the operating surface being a surface for moving the protrusion toward the second housing by a rotational movement of the connecting lever from the standby position to the fastening position, and
the extended cover portion extending toward an opening of the outer fitting peripheral wall portion along the slit with the connecting lever located at the fastening position.

2. The connector unit of claim 1, wherein a tip of the extended cover portion is along a direction orthogonal to an extension direction of the slit with the connecting lever located at the fastening position.

3. The connector unit of claim 2, wherein the extended cover portion has a pair of side edges extending from both ends of the tip of the extended cover portion toward a base end side of the extended cover portion while being orthogonal to the tip.

4. The connector unit of claim 1, wherein the extended cover portion is located at an opening edge of the outer fitting peripheral wall portion with the connecting lever located at the fastening position.

5. The connector unit of claim 1, wherein:
the first connector includes a plate portion projecting outward from a base end part of the inner fitting peripheral wall portion, and
a tip of the extended cover portion is facing the plate portion with the connecting lever located at the fastening position.

6. The connector unit of claim 2, wherein:
the extended cover portion rotates from the standby position to the fastening position by way of an intermediate position,
the operating surface has a first operating surface for contacting the protrusion with the connecting lever located between the standby position and the intermediate position and a second operating surface for contacting the protrusion with the connecting lever located between the intermediate position and the fastening position, and
a moving speed of the protrusion by the operating surface according to rotation of the connecting lever is faster by the second operating surface than by the first operating surface.
